(19) United States
(12) Patent Application Publication
(10) Pub. No.: US 2007/0089996 A1
(43) Pub. Date: Apr. 26, 2007

(54) Method of forming a cationic electrodeposition film forming an electric through hole and an electric through hole-forming cationic electrocoating composition

(75) Inventor: Yoshio Kojima, Neyagawa-shi (JP)

Correspondence Address: CONNOLLY BOVE LODGE & HUTZ LLP, P.O. BOX 2207, WILMINGTON, DE, 19899-2207, US

(73) Assignee: Nippon Paint Co., Ltd., Kita-ku, Osaka-shi (JP)

(21) Appl. No.: 10/571,424

(22) PCT Filed: Sep. 13, 2004
(86) PCT No.: PCT/JP04/13696

§ 371 Date: Jan. 7, 2007

(30) Foreign Application Priority Data
Sep. 11, 2003 (JP) 2003-320274

(51) Int. Cl. B01D 57/02; C25D 13/06

(52) U.S. Cl. 205/317; 204/470; 204/502; 205/320

(57) ABSTRACT

It is an object of the present invention to provide a method of forming a cationic electrodeposition film, which has no detrimental effect on basic performances of electrodeposition that a curing property in low temperature and the stability of pigment dispersion are good and basic performances such as corrosion resistance and a rust-preventive property are maintained while maintaining both surface smoothness and economical advantage and exhibits the extremely precise throwing power and can attain an excellent ability of preventing a pinhole due to gas. A method of forming a cationic electrodeposition film, comprising immersing an article to be coated, composed of a galvanized steel sheet, into a bath tank filled with a cationic electrocoating liquid containing a base resin and forming an electrodeposition film on the surface of the above galvanized steel sheet by current-carrying, wherein an electric through hole is formed within the above film to secure the conductivity of the above film in order to wipe out a spark discharge phenomenon arising due to the presence of a hydrogen bubble produced through cohesion of hydrogen gas, with the passage of time, generated by the above current-carrying at a gap of the film, which develops in depositing/forming the film by the above current-carrying and increasing its thickness with the passage of time, on the surface of the above galvanized steel sheet, and
thereby an increase in an electric resistance value (kΩ·cm²) per unit weight (mg) of the above film is inhibited.

### FIELD OF THE INVENTION

The present invention relates to a method of forming a cationic electrodeposition film and a cationic electrocoating composition which is preventive of a pinhole of zinc plating due to gas.

### BACKGROUND ART

Cationic electrocoating composition are provided in the form of a bath liquid to form under films on large articles to be coated such as an automobile body and the like, and in a method of forming a cationic electrodeposition film using the cationic electrocoating composition, generally, a bath tank is filled with such a bath liquid and a line is constructed by traveling a lane which suspends an article to be coated and articles to be coated are subsequently immersed in a bath tank. Then, a coating composition is deposited on the surface of the article to be coated by passing a current through an electrode (cathode) and an article to be coated (anode) and form an undercoat on the whole article to be coated, and after taking the article to be coated from the bath tank, they are washed with water, subjected to setting and cures by heat.

Such a cationic electrocoating composition is generally constituted by dispersing a cationic resin such as amine-modified epoxy resin, a crosslinking agent such as blocked isocyanate compound, a pigment dispersion paste containing a pigment dispersion resin and pigment, and another additives in an aqueous medium

Automobile bodies require high rust-preventive property, and in recent year a steel sheet plated with melted alloyed zinc (GA sheet) or a steel sheet electroplated with zinc (EG sheet) (these are referred to as a galvanized steel sheet totally) are generally used in place of a cold rolled steel sheet. Especially herein, a steel sheet plated with melted alloyed zinc (GA sheet) is referred to as a galvanized steel sheet.

Since electrodeposition can form an uniform film on the surface of a large article to be coated functionally, subsequently and efficiently using standard equipment, it is widely used for forming an under film of an automobile body. In such applications, corrosion resistance and rust-preventive property is required other than smoothness which does not have a detrimental effect on appearance of a finished film and further good throwing power, described later, is an essential requirement.

However, in electrodeposition, hydrogen gas (H₂) is necessarily produced from water (H₂O) in a bath liquid and electric charge (e⁻) generated during current-carrying on the surface of an article to be coated in forming an electrodeposition film. This hydrogen gas acts so as to interfere the formation of smooth film deposited with current-carrying, but the deposited film itself produces joule heat through electric resistance of the film and is melted and fuses to maintain certain uniformity to some extent. However, when a galvanized steel sheet is used as a steel sheet, voltage in discharging becomes lower than a steel sheet, and hydrogen gas generated is coalesced to form a substance in the form of a large bubble (this substance in the form of a large bubble is also referred to as “hydrogen bubble”), and by current-carrying spark discharge arises in this hydrogen bubble and a film causes precure (phenomenon in which the film is partially cured prior to subsequent heat curing) due to spark discharge energy at a lapse of 3 to 4 seconds after current-carrying is initiated (FIG. 1).

Such precure portions are covered with heat flow in the course of formation of an electrodeposition film and many of them does not leave a trace but part of them remains to generate a flaw like a crater on the film. A crater thus generated is referred to as “a pinhole due to gas” or “GA cratering” and well known. A performance capable of suppressing these is also referred to “the ability of preventing a pinhole due to gas” or expressed as “the ability of preventing a pinhole of zinc plating due to gas”, and considered to be important.

A pinhole due to gas degrades the appearance which is key point of coating of automobile bodies even after intermediate coating or top coating to cause the defect of appearance or causes cissing of intermediate film to reduce corrosion resistance. Therefore, the ability of preventing a pinhole due to gas is referred to as “suitability for a galvanized steel sheet” as an issue to be solved and has been an issue, which is essential for solution, of the cationic electrocoating composition for galvanized steel sheets.

As a simple method, there may be used, for example, a method of forming a flexible deposited film by adding a solvent to a bath liquid (Japanese Kokai Publication Sho-60-60169, Japanese Kokai Publication Sho-63-107786), but in these methods, there is a problem of reducing the throwing power reversely. And, for example when a film thickness is increased, it becomes easy to attain the ability of preventing a pinhole due to gas because depositing coating composition covers precure portions through heat flow. Though these can be achieved by increasing a ratio of a solvent in a bath, there is an obstruction against environmental problem of reducing VOC and the throwing power.

An inherent object to form an under film is that a rust-preventive property is enhanced and in addition to this appearance is enhanced by covering roughness (surface roughness) of a steel substrate. In this day, when coating technology becomes more advanced, it is considered that a proper thickness of an under film is about 10 μm at the minimum, and therefore it is required to maintain about 15 μm at the maximum for an external plate for the economical reason and to maintain about 10 μm at the minimum for an internal plate. Thus, extremely high throwing power is required.

In Japanese Kokai Publication Hei-10-36717, there is disclosed a cationic electrocoating composition containing an ethylene oxide adduct of secondary alcohol having HLB of 10.0 to 13.5 as a component exhibiting the ability of preventing a pinhole due to gas. It is stated that thereby, the high ability of preventing a pinhole due to gas can be attained without having no detrimental effect on a throwing power. However, this method was an epoch-making method in which a coating composition contained an agent preventing the occurrence of pinhole due to gas in order to develop the ability of preventing a pinhole due to gas, but since an ethylene oxide adduct of secondary alcohol was used as an additive for developing the ability of preventing a pinhole due to gas, the disadvantages, such as an increase in the viscosity of a bath liquid resulting from addition of additives and an accidental increase in a film thickness associated with this, is not completely eliminated.

In Japanese Kokai Publication Hei-11-323211, there is disclosed a cationic electrocoating composition in which pigment dispersion resin was devised to improve a pigment dispersion paste in order to exhibit the ability of preventing a pinhole due to gas and to maintain the stability of pigment dispersion, and the corrosion resistance and the high throwing power when the so-called low temperature baking at a temperature of 160° C. or lower was conducted, and a ratio of the pigment content in the cationic electrocoating composition to the total resin content (weight ratio) is in a range of 1:3 to 1:7. However, in this method, low solvent, high corrosion resistance, high weather resistance and workability were mainly noted and pigment dispersion paste was improved intended to maintain these, and therefore since this method does not have an effect on spark discharge phenomenon due to hydrogen bubble associated with the generation of hydrogen gas, it did not reach the substantial solution of a problem.

In Japanese Kokai Publication 2000-204299, it is disclosed that the ability of preventing a pinhole due togas can be attained for a galvanized steel sheet by a cationic electrodcoating composition in which the conductivity of a dilution coating is 1000 to 1300 μS/cm² and a coulomb efficiency of 3 minutes electrodeposition is 40 mg/coulomb or more. In Japanese Kokai Publication 2000-204299, it is described in paragraph 0003 that a pinhole due to gas is caused by spark discharge of hydrogen gas and curing of resin of a film due to heat resulting from spark discharge. Also, it is described in paragraph 0017 that when voltage is applied in electrodeposition, a large current flows immediately after voltage application and then the current decreases rapidly and subsequently reduced gradually and reaches steady current, and when a larger amount of current flows immediately after voltage application, spark discharge in hydrogen gas is apt to occur. Therefore, a subject of technology described in Japanese Kokai Publication 2000-204299 is that by adjusting the conductivity of a dilution coating within a certain range to reduce an amount of current immediately after the voltage application and to suppress the spark discharge in hydrogen gas.

Since there is an obstruction in the throwing power when only the conductivity is adjusted, it is intended to inhibit a side effect of reduction of the throwing power by simultaneously enhancing a coulomb efficiency of 3 minutes electrodeposition in Japanese Kokai Publication 2000-204299 (paragraph 0003). Accordingly, the technology described in Japanese Kokai Publication 2000-204299 intends to lower the conductivity and to simultaneously enhance the coulomb efficiency to develop only both advantages. Accordingly, this is a technology which can expect a sufficient effect, but it cannot completely eliminate the disadvantage of impairing the safety and is a countermeasure of an expectant treatment while an essential treatment for the occurrence of the pinhole due to gas in a galvanized steel sheet cannot be realized.

In Japanese Kokai Publication 2001-19878, there is disclosed technology in which a minimum film formation temperature is adjusted within plus or minus 5° C. of a set temperature of electrodeposition and conductivity during coating is adjusted within a range of 1000 to 1500 μS/cm² in order to facilitate to let the hydrogen gas generated in forming an electrodeposition film escape for the purpose of enhancing the ability of preventing a pinhole due to gas. A minimum film formation temperature refers to a temperature of an electrocoating bath liquid at which a film thickness becomes a minimum, and a set temperature of electrodeposition refers to a liquid temperature of a electrodeposition bath tank, established at a process line. That is, this method intends to suppress spark discharge resulting from hydrogen gas by adjusting a bath liquid temperature by a method of increasing a molecular weight of a cationic base resin, or changing a component of a curing agent to an aromatic compound or an alicyclic compound, or reducing a quantity of a solvent with high boiling point, or by specifying the conductivity during coating.

However, in accordance with technology described in Japanese Kokai Publication 2001-19878, it is possible to attain the ability of preventing a pinhole due to gas, but there is a disadvantage that sever operations are required since the temperature of a bath liquid and the conductivity during coating have to be simultaneously adjusted.

### BRIEF DESCRIPTION OF THE DRAWINGS

FIG. 1 is a conceptional view of cationic electrodeposition.

FIG. 2 is a view showing a relationship between an electric resistance value of a film (kΩ·cm²) (axis of ordinates) and an elapsed-time from the initiation of current-carrying (sec.) (axis of abscissas) in the cationic electrodeposition.

FIG. 3 is a schematic view showing the state of depositing/forming a film in accordance with a method of forming a cationic electrodeposition film of the present invention.

FIG. 4 is a perspective view showing an example of a box used in evaluating the throwing power.

FIG. 5 is an illustrative view showing an evaluation method of the throwing power.

### EXPLANATION OF THE NUMERICAL SYMBOLS

1 deposited film
2 hydrogen bubble
3 electric current
4 spark discharge
5 escape hole of hydrogen gas
11 resistance increasing curve of a conventional film
12 resistance increasing curve of a film of the present invention
21 electric current
22 conductive portion
23 article to be coated
24 hydrogen bubble
25 electric through hole
26 hydrogen bubble enlarged
30 box
31 galvanized steel sheet
32 galvanized steel sheet
33 galvanized steel sheet
34 galvanized steel sheet
35 through hole
36 container of electrodeposition
37 electrocoating composition
38 counter electrode

### SUMMARY OF THE INVENTION

In view of the above-mentioned state of the art, it is an object of the present invention to provide a method of forming a cationic electrodeposition film, which has no detrimental effect on basic performances of electrodeposition that a curing property in low temperature and the stability of pigment dispersion are good and basic performances such as corrosion resistance and a rust-preventive property are maintained while maintaining both surface smoothness and economical advantage and exhibits the extremely precise throwing power and can attain an excellent ability of preventing a pinhole due to gas.

The present invention relates to a method of forming a cationic electrodeposition film, comprising immersing an article to be coated, composed of a galvanized steel sheet, into a bath tank filled with a cationic electrocoating liquid containing a base resin and forming an electrodeposition film on the surface of the above galvanized steel sheet by current-carrying,

wherein an electric through hole is formed within the above film to secure the conductivity of the above film in order to wipe out a spark discharge phenomenon arising due to the presence of a hydrogen bubble produced through cohesion of hydrogen gas, with the passage of time, generated by the above current-carrying at a gap of the film, which develops in depositing/forming the film by the above current-carrying and increasing its thickness with the passage of time, on the surface of the above galvanized steel sheet, and

thereby an increase in an electric resistance value (kΩ·cm²) per unit weight (mg) of the above film is inhibited.

In the above method of forming a cationic electrodeposition film,

it is preferred that a component composing the above film comprises the above base resin, the above base resin is an amine-modified epoxy resin and the above electric through hole is formed by locating an acid group (—COO—) in the vicinity of an end amino group of the above amine-modified epoxy resin.

In the above method of forming a cationic electrodeposition film,

the acid group (—COO—) is preferably a product of a reaction of an acid anhydride and an amino group.

In the above method of forming a cationic electrodeposition film,

the above electric through hole is preferably one formed by locating an acid group derived from a resin containing an acid group, which is poorly soluble in water.

In the above method of forming a cationic electrodeposition film,

the above electric through hole is preferably one formed by locating an acid group derived from an amphoteric ion group-containing resin.

The present invention relates to a method of forming a cationic electrodeposition film, comprising immersing an article to be coated, composed of a galvanized steel sheet, into a bath tank filled with a cationic electrocoating liquid containing a base resin and forming an electrodeposition film on the surface of the above galvanized steel sheet by current-carrying,

wherein a spark discharge phenomenon in a hydrogen bubble on the surface of the above galvanized steel sheet is inhibited by controlling an increase in an electric resistance value (kΩ·cm²) per unit weight (mg) of the film deposited/formed by the above current-carrying.

The present invention relates to a method of forming a cationic electrodeposition film, comprising immersing an article to be coated, composed of a galvanized steel sheet, into a bath tank filled with a cationic electrocoating liquid containing a base resin and forming an electrodeposition film on the surface of the above galvanized steel sheet by current-carrying,

wherein an electric resistance value (kΩ·cm²) per unit weight (mg) of the film deposited/formed by the above current-carrying is 1.0 or less within 4 seconds after the above current-carrying is initiated and 2.0 or more after a lapse of 10 seconds after the above current-carrying is initiated.

The present invention relates to a method of forming a cationic electrodeposition film, comprising immersing an article to be coated, composed of a galvanized steel sheet, into a bath tank filled with a cationic electrocoating liquid containing a base resin and forming an electrodeposition film on the surface of the above galvanized steel sheet by current-carrying,

wherein an increase in an electric resistance value (kΩ·cm²) per unit weight (mg) of the above film is suppressed for 4 seconds from the initiation of current-carrying in order to wipe out a spark discharge phenomenon arising due to the presence of a hydrogen bubble produced through cohesion of hydrogen gas, with the passage of time, generated by the above current-carrying at a gap of the film, which develops in depositing/forming the film by the above current-carrying and increasing its thickness with the passage of time, on the surface of the above galvanized steel sheet.

In the above method of forming a cationic electrodeposition film,

it is preferred that the above current-carrying condition is a manner in which voltage is elevated at a constant rate in a condition of selecting 5 seconds as a duration until reaching a predetermined applied voltage and

in this condition a temperature of a bath liquid is 20 to 40° C. during coating,

a concentration of non-volatile matter of a bath liquid is 15 to 25% by weight during coating,

an area ratio between an article to be coated and an electrode is 1:1 to 2:1 and a distance between electrodes is 15 cm.

The present invention relates to a cationic electrocoating composition containing a base resin which can secure the conductivity of a film by forming an electric through hole within a film deposited/formed by current-carrying during cationic electrodeposition process, and inhibit an increase in an electric resistance value (kΩ·cm²) per unit weight (mg) of the above film.

In the above cationic electrocoating composition,

it is preferred that a component composing the above film comprises the above base resin, the above base resin is an amine-modified epoxy resin and the above electric through hole is formed by locating an acid group (—COO—) in the vicinity of an end amino group of the above amine-modified epoxy resin.

In the above cationic electrocoating composition,

the acid group (—COO—) is preferably a product of a reaction of an acid anhydride and an amino group.

In the above cationic electrocoating composition,

the above electric through hole is preferably one formed by locating an acid group derived from a resin containing an acid group, which is poorly soluble in water.

In the above cationic electrocoating composition,

the above electric through hole is preferably one formed by locating an acid group derived from an amphoteric ion group-containing resin.

The present invention relates to a cationic electrocoating composition

which can control an increase in an electric resistance value (kΩ·cm²) per unit weight (mg) of a film deposited/formed by current-carrying during cationic electrodeposition process.

The present invention relates to a cationic electrocoating composition

which can render an electric resistance value (kΩ·cm²) per unit weight (mg) of a film deposited/formed by current-carrying during cationic electrodeposition process 1.0 or less within 4 seconds after the current-carrying is initiated and 2.0 or more after a lapse of 10 seconds after the current-carrying is initiated.

The present invention relates to cationic electrocoating composition

which can suppress an increase in an electric resistance value (kΩ·cm²) per unit weight (mg) of a film for 4 seconds from the initiation of current-carrying in order to wipe out a spark discharge phenomenon arising due to the presence of a hydrogen bubble produced through cohesion of hydrogen gas, with the passage of time, generated by said current-carrying at a gap of the film, which develops in depositing/forming the film by current-carrying during cationic electrodeposition process and increasing its thickness with the passage of time.

In the above cationic electrocoating composition,

it is preferred that the above current-carrying condition is a manner in which voltage is elevated at a constant rate in a condition of selecting 5 seconds as a duration until reaching a predetermined applied voltage and

in this condition a temperature of a bath liquid is 20 to 40° C. during coating,

a concentration of non-volatile matter of a bath liquid is 15 to 25% by weight during coating,

an area ratio between an article to be coated and an electrode is 1:1 to 2:1 and a distance between electrodes is 15 cm.

### DETAILED DESCRIPTION OF THE INVENTION

Hereinafter, the present invention will be described in detail.

The first present invention relates to a method of forming a cationic electrodeposition film, comprising immersing an article to be coated, composed of a galvanized steel sheet, into a bath tank filled with a cationic electrocoating liquid containing a base resin and forming an electrodeposition film on the surface of the above galvanized steel sheet by current-carrying, wherein an electric through hole is formed within the above film to secure the conductivity of the above film in order to wipe out a spark discharge phenomenon arising due to the presence of a hydrogen bubble produced through cohesion of hydrogen gas, with the passage of time, generated by the above current-carrying at a gap of the film, which develops in depositing/forming the film by the above current-carrying and increasing its thickness with the passage of time, on the surface of the above galvanized steel sheet, and thereby an increase in an electric resistance value (kΩ·cm²) per unit weight (mg) of the above film is inhibited.

The feature of the above first present invention is that an electric throughhole is formed in a film. The above-mentioned electric through hole is an electric route formed within an electrodeposition film by the above method of forming a cationic electrodeposition film.

Since a formation of the above-mentioned electric through hole allows the electric route to exist within the electrodeposition film formed by cationic electrodeposition, the conductivity of the film can be secured. Therefore, since it is possible to pass a current through the above-mentioned electric through hole in cationic electrodeposition process, an increase in an electric resistance value (kΩ·cm²) per unit weight (mg) of an electrodeposition film to be formed can be inhibited.

In conventional cationic electrodeposition, a spark discharge phenomenon arose due to the hydrogen bubbles produced through cohesion of hydrogen gas, with the passage of time, generated by the above current-carrying at a gap of a film, which develops in depositing/forming the film by the current-carrying and increasing its thickness with the passage of time. However, in the method of forming a cationic electrodeposition film of the present invention, since the above electric through hole is formed in a film produced in increasing its thickness with the passage of time, it is possible to pass a current through the electric through hole in cationic electrodeposition process and therefore it is possible to prevent the spark discharge phenomenon due to the hydrogen bubbles from arising. Since thereby, the partial precure of the film is prevented, the occurrence of pinholes due to gas is prevented and the defect of appearance of the film can be inhibited. By the way, the above-mentioned hydrogen bubble refers to a substance in the form of a large bubble, which hydrogen gas generated on the surface of a galvanized steel sheet is coalesced with the passage of time to form.

The electric through hole is the electric route in the electrodeposition film formed at the beginning of electrodeposition by the above method of forming a cationic electrodeposition film and simultaneously suppresses an increase in an electric resistance value (kΩ·cm²) per unit weight (mg) of a film at the beginning of electrodeposition. However, when thickening of the film proceeds by electrodeposition, it becomes impossible to exert adequately a function of suppressing electric resistance as a electric route, and therefore the electric resistance of the electric route is raised. Accordingly, when thickening of the film proceeds, resistance of the portion thickened increases and relatively high resistance is exhibited even though the film is a thin film. As a result, it becomes possible to electrocoat the location where a film is not yet formed (for example, internal plates of automobile bodies) and thereby the throwing power can be improved.

Therefore, the above first present invention is characterized in that by forming the above-mentioned electric through hole, the defect of appearance of the film resulting from the occurrence of a pinhole due to gas is prevented and also the throwing power in cationic electrodeposition can be secured. And, since the present invention is intended to inhibit generation of craters resulting from the spark discharge by inhibiting the spark discharge arising in the above hydrogen bubble and to prevent the occurrence of a pinhole due to gas, this method is completely differs from conventional technology of suppressing a pinhole due to gas in idea.

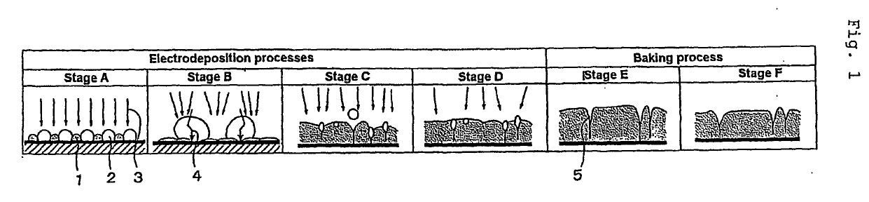

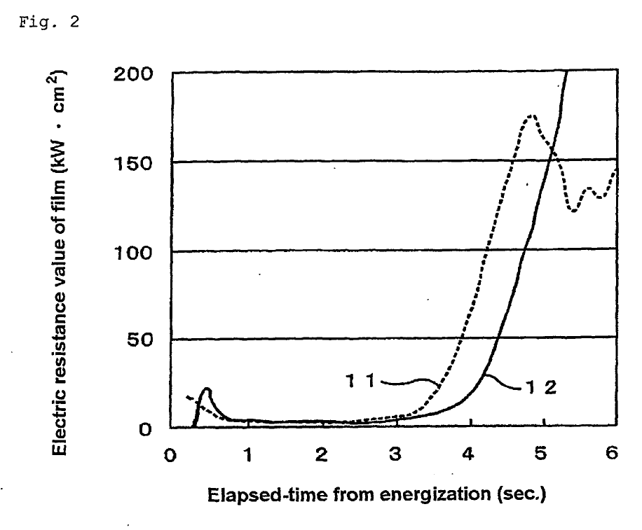

Feature of the above first present invention will be described by way of FIGS. 1 and 2.

As described in FIG. 2, when electrodeposition is conducted using a conventional cationic electrocoating composition (resistance increasing curve 11), a sharp rise in the electric resistance value (kΩ·cm²) of the film appears in a relatively short time (In FIG. 2, coating time about 3 seconds), but when the present invention is used (resistance increasing curve 12), a sharp rise in the electric resistance value (kΩ·cm²) of the film appears in a longer time compared with a conventional electrodeposition ((In FIG. 2, coating time about 4 seconds).

When a conventional electrodeposition is used, since a sharp rise in the electric resistance value of the film appears in a relatively short time, a spark discharge of a hydrogen bubble (hydrogen bubble enlarged at a stage B in FIG. 1 (spark discharge phenomenon of a spark discharge is indicated by an arrow “4” in part 2 in a stage A) arises at a stage B in FIG. 1 (In FIG. 2, this spark discharge phenomenon is exhibited as a temporary drop in the electric resistance value at about 4.75 seconds after current-carrying is initiated). And, the partial precure of the film occurs due to spark discharge energy by spark discharge phenomenon and a pinhole due to gas is produced in the obtained film and this causes a defect of appearance.

On the other hand, since the present invention is a method of retarding a timing of a sharp rise in the electric resistance value of the film compared with conventional electrodeposition by forming the above electric through hole, spark discharge phenomenon in the hydrogen bubbles does not arise and a temporary drop in the electric resistance value, which occurred at about 4.75 seconds, is not found. Therefore, the partial precure of the film resulting from spark discharge phenomenon in the hydrogen bubbles is inhibited and the pinhole due to gas is not generated, and the defect of appearance of the film to be obtained can be inhibited. The terms “suppress” and “inhibit” are used in a similar mean.

And, in the present invention (resistance increasing curve 12), thickening of a film proceeds and a sharp rise in the electric resistance value of the film is found after a lapse of certain time (coating time of about 4 seconds in FIG. 2). The reason for this is that because of proceeding of thickening, a network composed of the above electric through hole lapses its function and the electric route is lapsed, and therefore a sharp rise in the electric resistance value is found. Thus, the film exhibits relatively high resistance even though the film is a thin film due to an increase in the electric resistance value of the film, and it becomes possible to electrocoat the location where a film is not yet formed a certain time later and also to improve the throwing power.

That is, the present invention is characterized by providing a method of forming a film which can attain a characteristic such a resistance increasing curve 12 illustrated in FIG. 2, and thereby a film having the excellent appearance can be formed and the throwing power during electrodeposition can be secured.

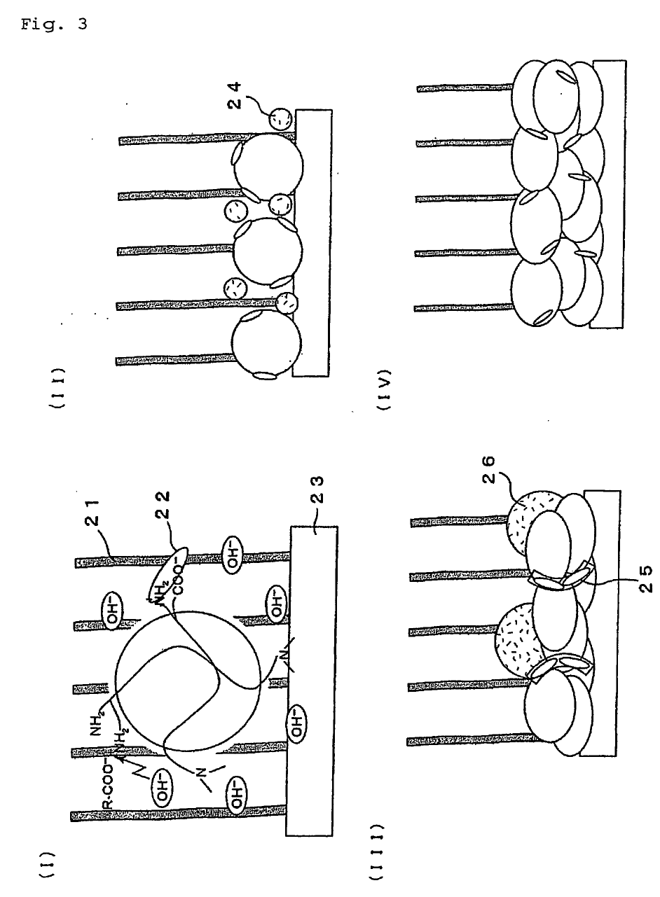

In the above first present invention, a mechanism that by forming the above electric through hole, the conductivity of the film is secured and an increase in an electric resistance value per unit weight of the film is suppressed and a mechanism of securing the throwing power will be described in detail below using FIG. 3.

FIG. 3 is a schematic view showing a state that a film is deposited/formed by using the method of forming a cationic electrodeposition film of the present invention. Part (I) shows a state that a cationic resin (amine-modified resin), which contains a conductive portion (—NH₂⁺, —COO—) in the vicinity of an end of resin, exists in a bath during cationic electrodeposition.

Part (II) shows an initial state that the cationic resin is deposited on an article to be coated and a film is formed by cationic electrodeposition. Here, it shows a state that the cationic resin is deposited by electrodeposition and also hydrogen gas is generated, and shows that the conductive portion in the resin is still present even after the cationic resin is deposited.

Part (III) shows a state that deposition of the cationic resin by electrodeposition proceeds gradually. Here, there is shown a state that a generated hydrogen gas is enlarged as the deposition/formation of the film proceeds. Also, there is shown a state that conductive portions existing in the resin are joined to form a network and form the electric through hole as the deposition of the resin proceeds. In conventional coating method, since the conductive portion does not exist in the resin, there is not a route where current flows when the deposition/formation of the film proceeds, and therefore spark discharge phenomenon arises in the enlarged hydrogen gas (hydrogen bubbles). On the other hand, in part (III) in the present invention, since the conductive portions form a network in the film, an electric through hole is formed and an increase in the electric resistance value per unit weight of the film is suppressed. As a result, a current flows in the electric through hole during electrodeposition and the occurrence of the spark discharge phenomenon in the enlarged hydrogen gas is suppressed. Therefore, the partial precure of the film due to spark discharge energy is inhibited and the ability of preventing a pinhole due to gas is created, and the film having the excellent appearance can be obtained.

Part (IV) shows a state that the deposition of the cationic resin by electrodeposition further proceeds than part (III). As shown in part (IV), by thickening of a film, the electric through hole crumbles and the resistance value of the network increases. Accordingly, a current value of the whole film thickened is suppressed, and therefore the electric resistance value per unit weight of the film at the location thickened increases. As a result, the deposition of the resin occurs efficiently at the location where the film is not yet thickened and it is possible to secure the throwing power. That is, in the present invention, the spark discharge phenomenon of hydrogen bubbles can be inhibited at the time (III) by the electric through hole, but simultaneously there is a route in which a current flows, and therefore thickening of a film at the site readily proceeds. Therefore, there is a problem that the throwing power against the location where a film formation not yet proceeds (for example, internal plates of automobile bodies) cannot be secured. But, by thickening of a film in part (IV), since the electric through hole crumbles and the electric resistance value per unit weight of the film increases, the film exhibits relatively high resistance even though the film is a thin film, and therefore it becomes possible to electrocoat the location where a film formation not yet proceeds and also to improve the throwing power. And, at the time of (IV), since spark discharge phenomenon due to the enlarged hydrogen gas does not occur, the precure of the film is suppressed and the ability of preventing a pinhole due to gas is exerted and the defect of appearance of the film is suppressed.

The above electric through hole is an electric route formed within an electrodeposition film by the above method of forming a cationic electrodeposition film as described above and formed, for example, from a substance having conductivity (a conductive portion).

The above-mentioned conductive portion is not specifically limited as long as it can become a route for a current passed by electrodeposition in the film deposited/formed by electrodeposition, and for example, a cationic group and an anionic group of the constituent components of the film can be given. In the present invention, when a substance, which can become a route of a current such as a cationic group and an anionic group, exists within the film, current flows preferentially in this portion and this suppresses the generation of spark discharge phenomenon in a hydrogen bubble.

As the above-mentioned cationic group, there can be given, for example, an amino group, a sulfonium group, an ammonium group and the like.

As the above-mentioned anionic group, there can be given, for example, a carboxyl group, a phosphate group, a sulfonate group and the like.

A method of locating the cationic group and the anionic group in the above-mentioned constituent components of the film is not specifically limited as long as it can locate the cationic group and the anionic group in the whole constituent components. For example, there can be given a method of introducing an acid group in a base resin (cationic resin) in a cationic electrocoating composition (method 1), a method of blending a resin containing an acid group, which is poorly soluble in water, as a constituent component in addition to the above base resin (cationic resin) in a cationic electrocoating composition (method 2), a method of blending an amphoteric ion group-containing resin in a cationic electrocoating composition (method 3) and a method of blending an hydroxy acid-blocked type curing agent (for example, blocked isocyanate blocked with an hydroxy acid) as a curing agent (method 4).

When the above method of introducing an acid group in a base resin (cationic resin) in a cationic electrocoating composition (method 1) is employed, a conductive portion can be introduced without substantially changing the formulation of the cationic electrocoating composition. As the above-mentioned acid group, there can be, for example, a carboxyl group, a phosphate group and a sulfonate group.

The above method of introducing an acid group in a base resin (cationic resin) in a cationic electrocoating composition is not specifically limited and for example, a publicly known method can be used. The acid group can be introduced, for example, by reacting an amino group existing in a cationic resin with an acid anhydride.

As the above-mentioned acid anhydride, there can be given, for example, maleic anhydride, trimellitic anhydride, phthalic anhydride and succinic anhydride. Among others, maleic anhydride is preferred from the view point of the ability of preventing a pinhole due to gas.

When the above method of blending a resin containing an acid group, which is poorly soluble in water, as a constituent component in addition to the above base resin (cationic resin) in a cationic electrocoating composition (method 2) is employed, a conductive portion in the above-mentioned constituent component comprises an acid group derived from a resin containing an acid group, which is poorly soluble in water. Further, when the method 2 is used, different kinds of acid groups can be introduced and the flexibility of design of a resin in which the acid group is introduced can be enhanced.

As an acid group used for the above-mentioned resin containing an acid group, which is poorly soluble in water, there can be given, for example, a carboxyl group, a sulfonate group and a sulfonium group.

The above resin containing an acid group, which is poorly soluble in water, is not specifically limited as long as it is a resin containing the acid group, which is poorly soluble in water, and for example, anionic resins such as acrylic resin, polyester resin and polyether resin can be given. As a method of producing above resin containing an acid group, which is poorly soluble in water, is not specifically limited and for example, a publicly known method of preparing resin containing the above acid group being poorly soluble in water can be used.

When the above method of blending an amphoteric ion group-containing resin in a cationic electrocoating composition (method 3) is employed, a conductive portion in the above constituent component comprises an acid group derived from an amphoteric ion group-containing resin. Further, when the method 3 is used, different kinds of acid groups can be introduced and the flexibility of design of a resin in which the acid group is introduced can be enhanced.

The above-mentioned amphoteric ion group-containing resin refers to a resin containing both of the above cationic group and the above anionic group. As a method of producing the above amphoteric ion group-containing resin is not specifically limited and for example, a publicly known method of preparing resin having a cationic group and an anionic group can be used.

As the above-mentioned amphoteric ion group-containing resin, there can be given, for example, a derivative formed by introducing an acid anhydride in aminopolyether and an amino acid-containing resin.

When the above method of blending an hydroxy acid-blocked type curing agent as a curing agent is employed, an acid group can be introduced without changing the formulation of another components. As the above-mentioned hydroxy acid, there can be given, for example, glycolic acid, citric acid, tartaric acid and the like.

As a method of producing the above-mentioned hydroxy acid-blocked type curing agent, there can be used a method similar to a publicly known method of reacting a curing agent with a blocking agent. The above hydroxy acid-blocked type curing agent can be obtained by reacting an hydroxy acid and a curing agent using in this method.

In the cationic electrocoating composition in the present invention, the above-mentioned base resin is a cationic resin.

The above-mentioned cationic resin is not specifically limited but, for example, an amine-modified resin is preferred and amino-modified epoxy resin is more preferred.

The above amino-modified epoxy resin is not specifically limited and, for example, a compound formed by aminating a bisphenol A epoxy resin with secondary amine can be given. When above base resin is amino-modified epoxy resin, the above electric through hole is more preferably formed by locating an acid group (—COO—) in the vicinity of an end amino group of the above amine-modified epoxy resin. Thereby, it is possible to inhibit the occurrence of a pinhole due to gas and to secure the throwing power adequately.

An epoxy resin, which can be used in the present invention, is generally polyepoxide.

The above-mentioned polyepoxide contains one or more 1,2-epoxy groups on an average in a molecule.

The above polyepoxide preferably has an epoxy equivalent of 180 (lower limit) to 1200 (upper limit). More preferably, the above lower limit is 375 and the above upper limit is 1000.

Among the above polyepoxides, polyglycidyl ether of polyphenol (for example, bisphenol A) is preferred. The above-mentioned polyglycidyl ether of polyphenols is prepared, for example, by etherizing polyphenol, and epichlorohydrin or dichlorohydrin in the presence of alkali. The above-mentioned polyphenol may be bis(4-hydroxyphenyl)-2-2-propane, 4-4′-dihydroxybenzophenone, bis(4-hydroxyphenyl)-1-1-ethane or analog thereof.

The above epoxy resin may be modified with an appropriate resin such as polyester polyol, polyether polyol or monofunctional alkylphenol. As a resin used for modification, there can be given, for example, polycaprolactone diol, a product of addition polymerization of ethylene oxide and the like.

As the secondary amine used for amination of the above epoxy resin, there can be given alkanol amines such as n-methylethanolamine, diethanolamine and diisopropanolamine; and alkyl amines such as diethylamine and dibutylamine. And, a ketimine compound, which is formed by blocking a primary amino group of a polyamine having at least one primary amino group such as diethylenetriamine and aminoethylethanolamine with ketones such as methyl isobutyl ketone and methyl ethyl ketone, may be used. These may be used alone or in combination of two or more species.

Further, when an acid group is introduced in a base resin (cationic resin) in a cationic electrocoating composition by a method 1, the above base resin is a cationic resin introduced with an acid group.

The cationic electrocoating composition in the present invention may contain a curing agent.

As the above-mentioned curing agent, blocked polyisocyanate is preferred. Among others, blocked polyisocyanate having a dissociation temperature of 100 to 180° C. is more preferred. The blocked polyisocyanate may exist in the composition as another component, or may be combined with another component into one. For example, half-blocked polyisocyanate may be reacted with a cationic resin to provide a crosslinking ability for the cationic resin. When the blocked polyisocyanate is not contained, a curing property may be insufficient. When a dissociation temperature of the blocked polyisocyanate is less than 100° C., the stability of coating composition is significantly poor and the practicality of coating composition cannot be attained. When it is more than 180° C., there is a possibility that a curing property is insufficient and corrosion resistance is reduced under the general baking conditions in many coating process line.

As the above-mentioned blocked polyisocyanate having a dissociation temperature of 100 to 180° C., there can be given all polyisocyanates, which have been conventionally used as a vehicle component for an electrocoating composition.

The above-mentioned polyisocyanates are not specifically limited and for example, aliphatic diisocyanates such as toluene diisocyanate, trimethylene diisocyanate, tetramethylene diisocyanate, pentamethylene diisocyanate, hexamethylene diisocyanate, 1,2-propylene diisocyanate, 1,2-butylene diisocyanate, 2,3-butylene diisocyanate, 1,3-butylene diisocyanate, ethylidene diisocyanate and buthylidene diisocyanate; alicyclic diisocyanates such as 1,3-cyclopentane diisocyanate, 1,4-cyclohexane diisocyanate, 1,2-cyclohexane diisocyanate and isophorone diisocyanate; aromatic diisocyanates such as m-phenylene diisocyanate, p-phenylene diisocyanate, 4,4′-diphenyl diisocyanate, 1,5-naphthalene diisocyanate and 1,4-naphthalene diisocyanate; aliphatic-aromatic diisocyanates such as 4,4′-diphenylmethane diisocyanate, 2,4- or 2,6-toluene diisocyanate or a mixture thereof, 4,4′-toluidine diisocyanate and 1,4-xylylene diisocyanate; nuclear substitution aromatic diisocyanate such as dianisidine diisocyanate, 4,4′-diphenylether diisocyanate and chlorodiphenyl diisocyanate; triisocyanates such as triphenylmethane-4,4′,4″-triisocyanate, 1,3,5-triisocyanate benzene and 2,4,6-triisocyanate toluene; tetraisocyanates such as 4,4′-diphenyl-dimethylmethane-2,2′,5,5′-tetraisocyanate; and polyisocyanates such as polymer of toluene diisocyanate dimer and toluene diisocyanate trimer can be given. These may be used alone or in combination of two or more species.

A block agent being dissociated at 100 to 180° C. may be used in the presence of catalyst. As the block agent being dissociated at 100 to 180° C. in the presence of catalyst, there can be given, for example, lower or higher alcohols such as methanol, ethanol, butanol and 2-ethylhexanol; cellosolves such as ethyl cellosolves, butyl cellosolves and hexyl cellosolves; aliphatic or heterocyclic alcohols such as furfuryl alcohol and an alkyl group-substituted furyfuryl alcohol; phenols such as phenol, m-cresol, p-nitrophenol, p-chlorophenol and nonylphenol; oximes such as methyl ethyl ketone oxime, methyl isobutyl ketone oxime, acetone oxime and cyclohexane oxime; active methylene compounds such as acetyl acetone, ethyl acetoacetate and ethyl malonate; and another such as caprolactam. These may be used alone or in combination of two or more species.

When a dissociation catalyst is used to the above blocked polyisocyanate curing agent, organic tin compounds such as dibutyltin laurate, dibutyltin oxide and dioctyltin, amines such as N-methyl morpholine, and metal salts such as lead acetate, strontium, cobalt and copper can be used. The concentration of a catalyst is generally 0.1 to 6% by weight with respect to the solid matter of a film-forming resin in the cationic electrocoating.

An amount of the above blocked polyisocyanate curing agent to be blended in the cationic electrocoating composition is preferably 10% by weight (lower limit) to 50% by weight (upper limit) with respect to 100% by weight of the solid matter of the coating. When the amount is less than 10% by weight, the coating has a defect of an insufficient curing property, and when it is more than 50% by weight, substances desorbed in baking a film are generated in large quantity, and this causes a problem that the smoothness of a film deteriorates or pollution arises due to a large amount of pitch, smoke and the like. More preferably, the above lower limit is 15% by weight and the above upper limit is 40% by weight.

In the above cationic electrocoating composition, a weight ratio of the above base resin to the above curing agent is preferably from 80:20 to 60:40. When an amount of the curing agent to be used is too less, the curing property becomes insufficient and when it is too many, substances desorbed in baking a film are generated in large quantity, and this causes a problem that the smoothness of a film deteriorates or pollution arises due to a large amount of pitch, smoke and the like.

The cationic electrocoating composition in the present invention may contains a pigment dispersion paste. The above-mentioned pigment dispersion paste is a mixture of a pigment dispersion resin and an appropriate pigment.

The above-mentioned pigment dispersion resin is not specifically limited and includes well known resins such as the above cationic resin. The above-mentioned pigment is not specifically limited and for example, coloring pigments such as carbon black, graphite, titanium dioxide and zinc oxide, extender pigments such as aluminum silicate and kaoline, and synthetic pigments such as aluminum phosphomolybdate can be given.

In the above-mentioned pigment dispersion paste, it is preferred that the above pigment dispersion resin is contained in an amount of from 1% by weight of lower limit (more preferably 5% by weight) to 40% by weight of upper limit (more preferably 30% by weight) as a solid matter. The content of the above pigment dispersion resin is preferably 1% by weight of lower limit to 20% by weight of upper limit (more preferably 15% by weight) with respect to the total solid matter of the cationic electrocoating composition.

The above-mentioned pigment is contained in such a way that a ratio of the pigment content in the cationic electrocoating composition to the total resin content (weight ratio) is in a range of 0:1 to 1:3. When this ratio exceeds 1:3, the ability of preventing a pinhole of zinc plating due to gas and the corrosion resistance may be reduced.

The cationic electrocoating composition in the present invention may contain another additives. As the above another additives, there can be given publicly known additives conventionally blended in the cationic electrocoating compositions.

The above-mentioned additive is not specifically limited and acids, which are used as a neutralizer in dispersing components composing a film in an aqueous medium, such as formic acid, acetic acid, lactic acid and sulfamic acid, and surfactants can be given. Preferably, the concentration of these additives is generally 0.1% by weight (lower limit) to 15% by weight (upper limit) with respect to 100% by weight of the resin solid matter in the cationic electrocoating composition. The above upper limit is more preferably 5% by weight. However, an amount of acids to be added is preferably selected so as to be 30 mg equivalent/100 g of solid matter or smaller as the concentration of a neutralizer.

As a component in the cationic electrocoating composition in the present invention, various organic solvents may be used other than water for dissolution of resin or adjustment of the viscosity.

The above-mentioned solvent is not specifically limited and for example, hydrocarbons (e.g. xylene or toluene), alcohols (e.g. methyl alcohol, n-butyl alcohol, isopropyl alcohol, 2-ethylhexyl alcohol, ethylene glycol, and propylene glycol), ethers (e.g. ethylene glycol monoethyl ether, ethylene glycol monobutyl ether, ethylene glycol monohexyl ether, propylene glycol monoethyl ether, 3-methyl-3-methoxybutanol, diethylene glycol monoethyl ether, and diethylene glycol monobutyl ether), ketones (e.g. methyl isobutyl ketone, cyclohexanone, isophorone, and acetyl acetone), esters (e.g. ethylene glycol monoethyl ether acetate, and ethylene glycol monobutyl ether acetate) and mixtures thereof can be given. The amount of the above solvent to be used is preferably from 0% by weight (lower limit) to 5% by weight (upper limit) with respect to the total coating material. Preferably, the above lower limit is 0.2% by weight and the above upper limit is 2% by weight.

The cationic electrocoating composition of the above first present invention can be prepared, for example, as described below. First, a base resin and a curing agent are mixed, and then an acid anhydride such as maleic anhydride is added to introduce a conductive portion into the base resin. Further, by adding a neutralizer, main emulsion dispersed in an aqueous medium is prepared. Then, a cationic electrocoating composition can be obtained by mixing the resulting emulsion, the above pigment dispersion paste, the above another additives and water.

In the present invention, electrodeposition in which a bath tank is filled with a bath liquid containing a cationic electrocoating composition and an article to be coated, composed of a galvanized steel sheet, is immersed in the above bath tank and an electrodeposition film is formed on the surface of the above galvanized steel sheet by current-carrying, is conducted in the conditions conventionally used commonly, that is, a coating bath temperature of 20 to 40° C., an applied voltage of 50 to 500 V and a current-carrying time of 30 seconds to 10 minutes in a state of an article to be coated to be fully immersed in a coating bath. A required thickness of the electrodeposition film preferably lies within a range of 5 μm (lower limit) to 50 μm (upper limit) in terms of baked film. Preferably, the above lower limit is 10 μm and the above upper limit is 35 μm.

Baking of the cationic electrodeposition film in the present invention is performed at a temperature of 100° C. (lower limit) to 200° C. (upper limit) as a temperature of the article to be coated for 5 to 50 minutes. Preferably, the above lower limit is 130° C. and the above upper limit is 160° C. However, the corrosion resistance of the above electrodeposition film will not be reduced even though it is baked at elevated temperatures of 160° C. or higher.

In the method of forming a cationic electrodeposition film of the present invention, the above-mentioned current-carrying condition is a manner in which voltage is elevated at a constant rate in a condition of selecting 5 seconds as a duration until reaching a predetermined applied voltage and in this condition a temperature of a bath liquid is 20 to 40° C. during coating, a concentration of non-volatile matter of a bath liquid is 15 to 25% by weight during coating, an area ratio between an article to be coated and an electrode is 1:1 to 2:1 and a distance between electrodes is 15 cm. Thereby, the throwing power and the ability of preventing a pinhole due to gas can be more precisely evaluated.

The second present invention relates to a method of forming a cationic electrodeposition film, comprising immersing an article to be coated, composed of a galvanized steel sheet, into a bath tank filled with a cationic electrocoating liquid containing a base resin and forming an electrodeposition film on the surface of the above galvanized steel sheet by current-carrying, wherein a spark discharge phenomenon in a hydrogen bubble on the surface of the above galvanized steel sheet is inhibited by controlling an increase in an electric resistance value (kΩ·cm²) per unit weight (mg) of the film deposited/formed by the above current-carrying.

The above second present invention is a method in which by controlling an increase in an electric resistance value (kΩ·cm²) of the film deposited/formed by the current-carrying, a spark discharge phenomenon in a hydrogen bubble on the surface of the above galvanized steel sheet is inhibited, and therefore the ability of preventing a pinhole of zinc plating due to gas can be exerted and the throwing power can also be improved.

In the above second present invention, an increase in an electric resistance value per unit weight of a film, which is formed through deposition and increases in its thickness as current-carrying proceeds with the passage of time, is controlled. The above-mentioned control can be achieved by various methods and it can be achieved, for example, by setting a timing when a sharp rise in an electric resistance value per unit weight of a film occurs at 4 seconds or more from the initiation of current-carrying.

In the above second present invention, a method of inhibiting a spark discharge phenomenon in a hydrogen bubble on the surface of the above galvanized steel sheet to improve the throwing power by controlling an increase in an electric resistance value (kΩ·cm²) per unit weight (mg) of the film deposited/formed by current-carrying in cationic electrodeposition, can be realized, for example, by forming the electric through hole described in the above first present invention.

As the cationic electrocoating composition used in the above second present invention, there can be given, for example, the same cationic electrocoating composition as that used in the above first present invention. And, the cationic electrodeposition in the above second present invention can also be conducted by a method similar to that of cationic electrodeposition in the above first present invention.

The third present invention relates to a method of forming a cationic electrodeposition film, comprising immersing an article to be coated, composed of a galvanized steel sheet, into a bath tank filled with a cationic electrocoating liquid containing a base resin and forming an electrodeposition film on the surface of the above galvanized steel sheet by current-carrying, wherein an electric resistance value (kΩ·cm²) per unit weight (mg) of the film deposited/formed by the above current-carrying is 1.0 or less within 4 seconds after the above current-carrying is initiated and 2.0 or more after a lapse of 10 seconds after the above current-carrying is initiated.

That is, the above third present invention is one which controls an electric resistance value (kΩ·cm²) per unit weight (mg) of a film deposited/formed by the above current-carrying so as to be 1.0 or less within 4 seconds after the above current-carrying is initiated and so as to be 2.0 or more after a lapse of 10 seconds after the above current-carrying is initiated.

Since the above third present invention is one controlling so as to be 1.0 or less within 4 seconds, the spark discharge phenomenon in a hydrogen bubble on the surface of the galvanized steel sheet can be inhibited. And, in addition to this, since it is one controlling so as to be 2.0 or more after a lapse of 10 seconds, an electric resistance value (kΩ·cm²) per unit weight (mg) of a film will increase after a lapse of 10 seconds. Thus, the film exhibits high resistance even when a formed film is a thin film, and therefore it becomes possible to form a film on the location like a internal plates of automobile bodies and it is possible to improve the throwing power. Accordingly, in the above third present invention, by controlling an electric resistance value (kΩ·cm²) per unit weight (mg) of a film at the beginning of current-carrying of electrodeposition, the compatibility between the ability of preventing a pinhole due to gas and the throwing power becomes possible.

In the above third present invention, a method of controlling an electric resistance value (kΩ·cm²) per unit weight (mg) of a film deposited/formed by current-carrying in cationic electrodeposition so as to be 1.0 or less within 4 seconds after the above current-carrying is initiated and so as to be 2.0 or more after a lapse of 10 seconds after the above current-carrying is initiated can be realized, for example, by forming an electric through hole described in the above first present invention.

As the cationic electrocoating composition used in the above third present invention, there can be given, for example, the same cationic electrocoating composition as that used in the above first present invention. And, the cationic electrodeposition in the above third present invention can also be conducted by a method similar to that of cationic electrodeposition in the above first present invention.

The fourth present invention relates to a method of forming a cationic electrodeposition film, comprising immersing an article to be coated, composed of a galvanized steel sheet, into a bath tank filled with a cationic electrocoating liquid containing a base resin and forming an electrodeposition film on the surface of the above galvanized steel sheet by current-carrying, wherein an increase in an electric resistance value (kΩ·cm²) per unit weight (mg) of the above film is suppressed for 4 seconds from the initiation of current-carrying in order to wipe out a spark discharge phenomenon arising due to the presence of a hydrogen bubble produced through cohesion of hydrogen gas, with the passage of time, generated by the above current-carrying at a gap of the film, which develops in depositing/forming the film by the above current-carrying and increasing its thickness with the passage of time, on the surface of the above galvanized steel sheet.

The above-mentioned fourth present invention relates to a method in which an increase in an electric resistance value (kΩ·cm²) per unit weight (mg) of the film is suppressed for 4 seconds from the initiation of current-carrying. That is, it is a method of controlling so as to retard timing when a rise in an electric resistance value (kΩ·cm²) per unit weight (mg) of the film occurs compared with a conventional coating method. Thereby, the spark discharge phenomenon arising due to the presence of a hydrogen bubble is prevented, and therefore the ability of preventing a pinhole of zinc plating due to gas can be exerted and the throwing power can also be improved.

In the above fourth present invention, a method of suppressing an increase in an electric resistance value (kΩ·cm²) per unit weight (mg) of the above film for 4 seconds from the initiation of current-carrying in order to wipe out a spark discharge phenomenon arising due to the presence of a hydrogen bubble produced through cohesion of hydrogen gas, with the passage of time, generated by the above current-carrying at a gap of the film, which develops in depositing/forming the film by current-carrying in cationic electrocoating and increasing its thickness with the passage of time can be realized, for example, by forming the electric through hole described in the above first present invention.

As the cationic electrocoating composition used in the above fourth present invention, there can be given, for example, the same cationic electrocoating composition as that used in the above first present invention. And, the cationic electrodeposition in the above fourth present invention can also be conducted by a method similar to that of cationic electrodeposition in the above first present invention.

The fifth present invention relates to a cationic electrocoating composition containing a base resin, being one in which, by forming an electric through hole within a film deposited/formed by current-carrying during cationic electrodeposition process, the conductivity of the film can be secured and an increase in an electric resistance value (kΩ·cm²) per unit weight (mg) of the above film can be inhibited.

The cationic electrocoating composition of the above fifth present invention has the excellent ability of preventing a pinhole due to gas and the throwing power since it is one in which by forming an electric through hole within the film deposited/formed by current-carrying during cationic electrodeposition, the conductivity of the above film can be secured and the increase in an electric resistance value per unit weight of the above film can be inhibited.

As a base resin in the cationic electrocoating composition of the above fifth present invention, there can be given, for example, a substance similar to the base resin in the above first present invention. Among others, it is preferred that the above base resin is an amine-modified epoxy resin and the above electric through hole is formed by locating an acid group (—COO—) in the vicinity of an end amino group of the above amine-modified epoxy resin. Thereby, it is possible to further inhibit the occurrence of a pinhole due to gas and to secure the throwing power adequately.

In the above fifth present invention, as the above-mentioned acid group (—COO—), there can be given, for example, a product produced by a reaction of an acid anhydride and an amino group. The above-mentioned acid anhydride includes, for example, the acid anhydride in the above first present invention.

The electric through hole in the cationic electrocoating composition of the above fifth present invention is similar to that in the above first present invention. Among others, the electric through holes formed by locating an acid group derived from a resin containing an acid group, which is poorly soluble in water and by locating an acid group derived from an amphoteric ion group-containing resin are preferred. Thereby, it is possible to inhibit the occurrence of a pinhole due to gas and to secure the throwing power adequately.

As the cationic electrocoating composition of the above fifth present invention, there can be given, for example, a substance similar to the cationic electrocoating composition in the above first present invention.

The sixth present invention relates to a cationic electrocoating composition which can control an increase in an electric resistance value (kΩ·cm²) per unit weight (mg) of a film deposited/formed by current-carrying during cationic electrodeposition process.

By using the above cationic electrocoating composition, the increase in an electric resistance value (kΩ·cm²) of the film can be controlled, and therefore the spark discharge phenomenon in a hydrogen bubble on the surface of the above galvanized steel sheet can be inhibited and the ability of preventing a pinhole of zinc plating due to gas can be improved. As the cationic electrocoating composition of the above sixth present invention, there can be given, for example, a substance similar to the cationic electrocoating composition in the above second present invention.

The seventh present invention relates to a cationic electrocoating composition which can render an electric resistance value (kΩ·cm²) per unit weight (mg) of a film deposited/formed by current-carrying during cationic electrodeposition process 1.0 or less within 4 seconds after the current-carrying is initiated and 2.0 or more after a lapse of 10 seconds after the current-carrying is initiated.

By using the cationic electrocoating composition of the above seventh present invention, the compatibility between the ability of preventing a pinhole due to gas and the throwing power becomes possible. As the cationic electrocoating composition of the above seventh present invention, there can be given, for example, a substance similar to the cationic electrocoating composition in the above third present invention.

The eighth present invention relates to a cationic electrocoating composition which can suppress an increase in an electric resistance value (kΩ·cm²) per unit weight (mg) of a film for 4 seconds from the initiation of current-carrying in order to wipe out a spark discharge phenomenon arising due to the presence of a hydrogen bubble produced through cohesion of hydrogen gas, with the passage of time, generated by the above current-carrying at a gap of the film, which develops in depositing/forming the film by current-carrying during cationic electrodeposition process and increasing its thickness with the passage of time.

By using the cationic electrocoating composition of the above eighth present invention, the spark discharge phenomenon arising due to the presence of a hydrogen bubble is prevented, and therefore the ability of preventing a pinhole due to gas can be exerted. As the cationic electrocoating composition of the above eighth present invention, there can be given, for example, a substance similar to the cationic electrocoating composition in the above fourth present invention.

In the cationic electrocoating compositions of the above present seventh and eighth inventions, it is preferred that the above-mentioned current-carrying condition is a manner in which voltage is elevated at a constant rate in a condition of selecting 5 seconds as a duration until reaching a predetermined applied voltage and in this condition a temperature of a bath liquid is 20 to 40° C. during coating, a concentration of non-volatile matter of a bath liquid is 15 to 25% by weight during coating, an area ratio between an article to be coated and an electrode is 1:1 to 2:1 and a distance between electrodes is 15 cm.

The method of forming a cationic electrodeposition film of the present invention is a method in which an electric through hole is formed within the above film to secure the conductivity of the above film in order to wipe out a spark discharge phenomenon arising due to the presence of a hydrogen bubble produced through cohesion of hydrogen gas, with the passage of time, generated by the above current-carrying at a gap of the film, which develops in depositing/forming the film by the current-carrying and increasing its thickness with the passage of time, and thereby an increase in an electric resistance value (kΩ·cm²) per unit weight (mg) of the above film can be inhibited. That is, in this method, since the conductivity of the film is secured by forming the above electric through hole, it is possible to suppress the partial precure of the film due to spark discharge energy. Accordingly, since the occurrence of pinholes after curing the electrode position film can be inhibited and the defect of appearance of the film resulting from pinholes can be prevented, it is a method having the excellent ability of preventing a pinhole due to gas. Since it inhibits the increase in an electric resistance value (kΩ·cm²) per unit weight (mg) of the film by forming the above electric through hole, a film to be formed will exhibit relatively high resistance even when it is a thin film. Therefore, it becomes possible to electrocoat the location where a film thickness is not yet thickened (for example, internal plates of automobile bodies) and also to improve the throwing power. And, it is also a method which has no detrimental effect on basic performances of electrodeposition of maintaining basic performances such as corrosion resistance and a rust-preventive property. Accordingly, it is a method which can be suitably applied to the galvanized steel sheets to be used in an automobile body.

Since the method of forming a cationic electrodeposition film of the present invention is constituted as described above, it is a method which is excellent in the ability of preventing a pinhole due to gas and the throwing power and has no detrimental effect on basic performances of electrodeposition.

### BEST MODES FOR CARRYING OUT THE INVENTION

Hereinafter, the present invention will be described in more detail by way of examples, but the present invention is not limited to these examples. In addition, “part(s)” refers to “part(s) by weight” in Examples, unless otherwise specified.

### Production Example 1

Preparation of a Modified Epoxy Resin 1 Having a Cationic Group

Into a flask equipped with a stirrer, a cooling tube, a nitrogen gas inlet pipe, a thermometer and a dropping funnel were charged 940 parts of a liquid epoxy resin, 59.5 parts of methyl isobutyl ketone (hereinafter, referred to as MIBK) and 24.4 parts of methanol. After a temperature of this reaction mixture was increased from room temperature to 40° C. under stirring, 0.01 part of dibutyltin laurate and 21.8 parts of trilene diisocyanate (hereinafter, referred to as TDI) were charged into the mixture. A reaction was continued at 40 to 45° C. for 30 minutes. The reaction was continued until the absorption based on an isocyanate group was dissipated in measuring infrared spectrums.

To the above reactant were added 82.0 parts of poly(oxyethylene) bisphenol A ether and 125.0 parts of methylene diisocyanate (hereinafter, referred to as MDI). A reaction was conducted at 55 to 60° C. and continued until the absorption based on an isocyanate group was dissipated in measuring infrared spectrums.

Subsequently, the reactant temperature was increased and 2.0 parts of N,N-dimethylbenzylamine was charged into this at 100° C. The mixture was maintained at 130° C. and reacted with methanol while distilling off methanol by fractional distillation using a fractional tube, and as a result, an epoxy equivalent of the reactant became 286.

Then, the reactant was diluted with MIBK until a non-volatile content became 91.2% and the reaction mixture was cooled, and to this were charged 268.1 parts of bisphenol A and 93.6 parts of 2-ethylhexanoic acid. The reaction was conducted at 120 to 125° C., and when the epoxy equivalent became 1,490, the reaction mixture was diluted with MIBK until a non-volatile content became 85.3% and then cooled.

To this, 93.6 parts of diethylenetriamine, a primary amine of which is blocked with MIBK, and 53.8 parts of N-methylethanolamine were added and the resulting mixture was reacted at 120° C. for 1 hour to obtain a modified epoxy base resin (resin solid content 85.1%) having a cationic group.

### Production Example 2

Preparation of a Modified Epoxy Resin 2 Having a Cationic Group

Into a flask equipped with a stirrer, a cooling tube, a nitrogen gas inlet pipe, a thermometer and a dropping funnel were charged 546.2 parts of a liquid epoxy resin, 36.7 parts of MIBK and 19.3 parts of methanol. After a temperature of this reaction mixture was increased from room temperature to 50° C. under stirring, 0.07 part of dibutyltin laurate and 43.6 parts of TDI were charged into the mixture. A reaction was continued at 40 to 45° C. for 30 minutes. The reaction was continued until the absorption based on an isocyanate group was dissipated in measuring infrared spectrums.

Subsequently, the mixture temperature was increased and 0.8 part of N,N-dimethylbenzylamine was charged into this at 100° C. The mixture was maintained at 130° C. and reacted with methanol while distilling off methanol by fractional distillation using a fractional tube, and as a result, an epoxy equivalent of the mixture became 242

Then, the reactant was diluted with MIBK until a non-volatile content became 82.9% and the reaction mixture was cooled, and to this were charged 160.2 parts of bisphenol A and 52.6 parts of 2-ethylhexanoic acid. The reaction was conducted at 120 to 125° C., and when the epoxy equivalent became 1,200, the reaction mixture was diluted with MIBK until a non-volatile content became 80.84% and then cooled.

To this, 43.6 parts of diethylenetriamine, a primary amine of which is blocked with MIBK, and 36.3 parts of N-methylethanolamine were added and the resulting mixture was reacted at 120° C. for 1 hour to obtain a modified epoxy base resin having a cationic group.

### Production Example 3

Preparation of Blocked Isocyanate Curing Agent

1333 parts of MDI, 276.1 parts of MIBK and 2 parts of dibutyltin laurate were put in a reaction vessel and heated to 85 to 95° C., and then 1170 parts of a solution (equivalent ratio of 20:80) formed by dissolving caprolactam in ethylene glycol monobutyl ether was added dropwise into the above-mentioned reaction vessel over 2 hours. After the completion of adding dropwise, a temperature of the mixture was increased to 100° C. and maintained at this temperature for 1 hour. After recognizing that the absorption based on an isocyanate group was dissipated in measuring infrared spectrums, 347.6 parts of MIBK was charged to the reactant to obtain a blocked isocyanate curing agent.

### Production Example 4

Preparation of Pigment Dispersion Resin

Into a reaction vessel equipped with a stirrer, a cooling tube, a nitrogen gas inlet pipe and a thermometer were charged 2220 parts of isophorone diisocyanate (hereinafter, referred to as IPDI) and 342.1 parts of MIBK. A temperature of this mixture was increased and 2.2 parts of dibutyltin laurate was charged at 50° C. and 878.7 parts of methyl ethyl ketone oxime (hereinafter, referred to as MEK oxime) was charged at 60° C. into the mixture. Then, a temperature of the mixture was maintained at 60° C. for 1 hour, and after recognizing that NCO equivalent became 348, 890 parts of dimethylethanolamine was added. The mixture was maintained at 60° C. for 1 hour, and after recognizing that a NCO peak was dissipated by infrared spectrums, 17.8 parts of MEK oxime and 204.2 parts of ethylene glycol monoethyl ether were charged into the mixture. 1872.6 parts of a 50% solution of lactic acid and 273.8 parts of deionized water was added while cooling the mixture so as not to exceed 60° C. to obtain a quaterlizing agent.

In a reaction vessel equipped with a stirrer, a cooling tube, a nitrogen gas inlet pipe and a thermometer, 940.0 parts of a liquid epoxy resin was diluted with 38.5 parts of methanol, and then to this was added 0.1 part of dibutyltin dilaurate. After a temperature of this mixture was increased to 50° C., 87.1 parts of TDI was added and the temperature was further increased. 1.4 parts of N,N-dimethylbenzylamine was added to this at 100° C. and kept at 130° C. for two hours. In this time, methanol was distilled off by fractional distillation with a fractionation tube.

The distilled mixture was cooled to 115° C. and MIBK was charged into this until solid matter content became 90%. Then, into this, 270.3 parts of bisphenol A and 39.2 parts of 2-ethylhexanoic acid were charged and the mixture was heated to 125° C., and stirred and maintained at this temperature for two hours. Then, 516.4 parts of the blocked isocyanate curing agent prepared in Production Example 3 was added dropwise over 30 minutes, and then the mixture was heated and stirred for 30 minutes.

1506 parts of poly(oxyethylene) bisphenol A ether was gradually added to and dissolved in this mixture. After the resulting solution was cooled to 90° C., the above-mentioned quaterlizing agent was added, and the mixture was maintained at 70 to 80° C. and a pigment dispersion resin (resin solid content 30%) was obtained after recognizing the acid value of 2 or lower.

### Production Example 5

Preparation of Pigment Dispersion Paste

Into a sand grind mill were put 106.9 parts of the pigment dispersion resin obtained in Production Example 4, 1.6 parts of carbon black, 40 parts of kaolin, 55.4 parts of titanium dioxide, 3 parts of aluminum phosphomolybdate, 11.7 parts of dibutyltin oxide and 11.9 parts of deionized water, and the mixture was dispersed until reaching a particle size of 10 μm or smaller to obtain a pigment dispersion paste (solid matter content 60%).

### Production Example 6

Preparation of Amino Polyether Introduced with an Acid Anhydride

In a flask equipped with a stirrer, a cooling tube, a nitrogen gas inlet pipe, a thermometer and a dropping funnel, 362 parts of amino polyether having an amine value of 255 (a propylene oxide a duct of diethylenetriamine produced by Sanyo Chemical Industries, Ltd., trade name: AP-10, molecular weight 684) was mixed with 49 parts of maleic anhydride at 90° C. for 30 minutes to obtain amino polyether introduced with an acid anhydride.

### Production Example 7

Preparation of Blocked Isocyanate Introduced with Hydrhydroxy Acid

Into a flask equipped with a stirrer, a cooling tube, a nitrogen gas inlet pipe, a thermometer and a dropping funnel were charged 226.6 parts by weight of isophorone diisocyanate, 56.7 parts by weight of MIBK and 0.2 part by weight of dibutyltin laurate, and to this mixture, 142.1 parts by weight of methyl ethyl ketone oxime (hereinafter, referred to as MEK oxime) was added dropwise at 40° C. while stirring. Then, 31.0 parts of glycolic acid was added and the resulting mixture was stirred at 70 to 75° C. for 10 hours to obtain blocked isocyanate introduced with hydrhydroxy acid.

### Production Example 8

Preparation of a Quaternary Ammonium Resin

Into a flask equipped with a stirrer, a cooling tube, a nitrogen gas inlet pipe, a thermometer and a dropping funnel were charged 941.1 parts of a liquid epoxy resin, 155.6 parts of MIBK, 355.2 parts of bisphenol A and 103.7 parts of 2-ethylhexanoic acid. After a temperature of this mixture was increased to 100° C., 7.5 parts of by weight of a 2% by weight xylol solution of 2-ethyl-4-methylimidazole was added, and the temperature was further increased to 145° C. and maintained. When an epoxy equivalent of a reaction mixture became 1296, the reaction mixture was diluted with MIBK until a non-volatile content became 70% and cooled to obtain a quaternary ammonium resin.

### Example 1

Preparation of a Cationic Electrocoating Composition

The modified epoxy resin 1 having a cationic group, which was obtained in Production Example 1, and the blocked isocyanate curing agent prepared in Production Examples 3 were homogeneously mixed in a blending ratio as solid matter of 70:30. Then, to this mixture was added an aqueous solution of maleic anhydride, which was formed by previously adding 1.5 equivalent of deionized water to maleic anhydride and stirring it at 85 to 90° C. for 30 minutes, in such a way that an acid value became 3.9 with respect to the resin solid content. To this mixture, glacial acetic acid was added in such a way that a neutralization ratio is 37.7% and further deionized water was gradually added to dilute the mixture. An emulsion containing a solid matter content of 38% was obtained by removing MIBK while reducing pressure. 1758.2 parts of this emulsion, 221 parts of pigment dispersion paste obtained in Production Example 5 and 2020.7 parts of deionized water were mixed to obtain a cationic electrocoating composition containing a solid matter content of 20% by weight. A ratio of pigment to resin solid content in the cationic electrocoating composition was 1:7.0.

### Example 2

Preparation of a Cationic Electrocoating Composition

The modified epoxy resin 1 having a cationic group, which was obtained in Production Example 1, and the blocked isocyanate curing agent prepared in Production Examples 3 were homogeneously mixed in a blending ratio as solid matter of 70:30. Then, to this mixture was added an amino polyether introduced with an acid anhydride, prepared in Production Example 6, in such a way that an acid value became 3.9 with respect to the resin solid content. To this mixture, glacial acetic acid was added in such a way that a neutralization ratio is 37.7% and further deionized water was gradually added to dilute the mixture. An emulsion containing a solid matter content of 38% was obtained by removing MIBK while reducing pressure. 1758.2 parts of this emulsion, 221 parts of pigment dispersion paste obtained in Production Example 5 and 2020.7 parts of deionized water were mixed to obtain a cationic electrocoating composition containing a solid matter content of 20% by weight. A ratio of pigment to resin solid content in the cationic electrocoating composition was 1:7.0.

### Example 3

Preparation of a Cationic Electrocoating Composition

Into the modified epoxy resin 1 having a cationic group obtained in Production Example 1, the blocked isocyanate introduced with hydrhydroxy acid obtained in Production Example 7 was charged in such a way that a MEQ (A) became 3.9 in the solid content of a coating material, and further the blocked isocyanate curing agent prepared in Production Examples 3 was added in such a way that a ratio of the modified epoxy resin 1 to the total amount of the blocked isocyanate introduced with hydrhydroxy acid and the blocked isocyanate curing agent was 70:30, and the resulting mixture was stirred at 90°° C. for 30 minutes. After stirring, glacial acetic acid was added in such a way that a neutralization ratio is 37.7% and further deionized water was gradually added to dilute the mixture. An emulsion containing a solid matter content of 38% was obtained by removing MIBK while reducing pressure. 1758.2 parts of this emulsion, 221 parts of pigment dispersion paste obtained in Production Example 5 and 2020.7 parts of deionized water were mixed to obtain a cationic electrocoating composition containing a solid matter content of 20% by weight. A ratio of pigment to resin solid content in the cationic electrocoating composition was 1:7.0.

### Example 4

Preparation of a Cationic Electrocoating Composition

The modified epoxy resin 1 having a cationic group obtained in Production Example 1 and the quaternary ammonium resin obtained in Production Example 8 corresponding to 5% by weight of the total resin quantity were mixed, and further into this mixture, the blocked isocyanate curing agent prepared in Production Examples 3 was charged in such a way that a ratio of the base resin to the blocked isocyanate curing agent is 70:30, and the resulting mixture was stirred at 90° C. for 30 minutes. After stirring, glacial acetic acid was added in such a way that a neutralization ratio is 37.7% and further deionized water was gradually added to dilute the mixture. An emulsion containing a solid matter content of 38% was obtained by removing MIBK while reducing pressure. 1758.2 parts of this emulsion, 221 parts of pigment dispersion paste obtained in Production Example 5 and 2020.7 parts of deionized water were mixed to obtain a cationic electrocoating composition containing a solid matter content of 20% by weight. A ratio of pigment to resin solid content in the cationic electrocoating composition was 1:7.0.

### Example 5

Preparation of a Cationic Electrocoating Composition

The modified epoxy resin 1 having a cationic group obtained in Production Example 1 and the blocked isocyanate curing agent prepared in Production Examples 3 were homogeneously mixed in a blending ratio as solid matter of 70:30. Then, to this mixture was added polyethylene glycol having an average molecular weight of 2000. To this mixture, zinc acetate was added so as to be 500 ppm as metal zinc and glacial acetic acid was added in such a way that a neutralization ratio is 37.7% and further deionized water was gradually added to dilute the mixture. An emulsion containing a solid matter content of 38% was obtained by removing MIBK while reducing pressure. 1758.2 parts of this emulsion, 221 parts of pigment dispersion paste obtained in Production Example 5 and 2020.7 parts of deionized water were mixed to obtain a cationic electrocoating composition containing a solid matter content of 20% by weight. A ratio of pigment to resin solid content in the cationic electrocoating composition was 1:7.0.

### Comparative Example 1

A cationic electrocoating composition was obtained in the same manner as that of Example 1, except for not mixing the deionized water and the maleic anhydride

### Comparative Example 2

A cationic electrocoating composition was obtained in the same manner as that of Example 2 except for not mixing the amino polyether introduced with an acid anhydride, prepared in Production Example 6.

The cationic electrocoating compositions obtained in the above-mentioned Examples 1 to 5 and Comparative Examples 1 and 2 were evaluated on the following items. The results of evaluation were shown in Table 1.

(Throwing Power)

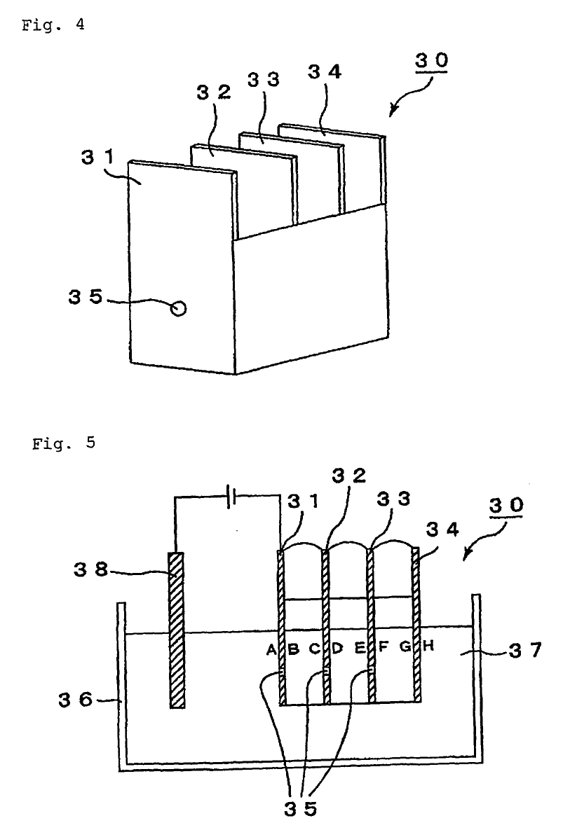

Throwing power was evaluated by the so-called four sheet box method. That is, as shown in FIG. 4, there was used a box 30 in which 4 sheets of a steel sheet treated with zinc phosphate (SPCC-SD treated with SURF DYNE SD-5000 (produced by NIPPON PAINT Co., Ltd.) according to JIS G 3141) 31 to 34 were located in parallel at a distance of 20 mm in a state of standing and lower sections of both sides and a bottom face are sealed with an insulator such as a cloth self-adhesive tape. In addition, each of steel sheets 31 to 33 other than a steel sheet 34 was provided with a through hole 35 of 8 mm in a diameter at the lower section. As shown in FIG. 5, this box 30 was immersed in a container of electrodeposition 36 in which the electrocoating composition 37 of the respective Examples or Comparative Examples was put and this box was constructed in such a way that the electrocoating composition 37 intruded into the box 30 only through the through hole 35. Respective steel sheet were electrically connected to one another and a counter electrode 38 was placed in such a way that a distance to the nearest steel sheet 31 was 150 mm. Respective steel sheets 31 to 34 were used as a cathode and the counter electrode 38 was used as an anode, and voltage was applied to the electrodes to cationic electrocoat a steel sheet. Coating was conducted by boosting voltage to a voltage by which a film thickness of a film formed on the A surface of the steel sheet 31 reached 20 μm in 5 seconds from the initiation of the voltage application and maintaining at this voltage for 175 seconds. Then, a set temperature of electrodeposition is adjusted to 28° C. Each coated steel sheet was washed with water and baked at 160° C. for 20 minutes and cooled with air. Then, a film thickness of a film formed on the A surface of the steel sheet 31 which was most close to the counter electrode 38 and a film thickness of a film formed on the G surface of the steel sheet 34 which was most far from the counter electrode 38 were measured and throwing power was evaluated by a ratio (G/A value) of a film thickness (G surface) to a film thickness (A surface). An electrocoating composition having a higher G/A value was considered to have good throwing power in the evaluation.

(Ability of Preventing a Pinhole Due to Gas)

After voltage applied to a chemically treated steel sheet plated with melted alloyed zinc was boosted to 200 V, 220 V and 240 V, respectively, in 5 seconds, each of the coating compositions of the respective Examples or Comparative Examples was electrocoated in 175 seconds and then washed with water and baked at 160° C. for 10 minutes and observed on a state of the surface. Incidentally, a container 36 in FIG. 5 was used, a distance between electrodes was set at 15 cm and a liquid depth was set at 10 cm. And, an area of the electrode was selected in such a way that a ratio between an anode and a cathode, opposed to each other, is 1:1. An electrodeposition in which a crater was generated at higher voltage was considered to have an excellent ability of preventing a pinhole due to gas in the evaluation.

Criteria for evaluation were as follows;

⊚; number of pinholes is less than 0.1/cm².

◯; number of pinholes is 0.1/cm² or more and less than 1.0/cm²

Δ; number of pinholes is 1.0/cm² or more and less than 5.0/cm²

X; number of pinholes is 5.0/cm² or more

(Electric Resistance Value Per Unit Weight)

A container of FIG. 5 was used, a chemically treated steel sheet plated with melted alloyed zinc was immersed and coated under the conditions that an area of an article to be coated was 140 cm², an area ratio between an electrode and the article to be coated is 1:2 and a distance between electrodes was 15 cm. Voltage of coating was elevated to predetermined voltage in 5 seconds at a constant rate and then maintained at the predetermined voltage. Weight of the steel sheet had been weighed in advance, and a current-carrying time was set from 2 seconds to 3 seconds inone second intervals, and after a residual current at the time when coating was completed was recorded, the steel sheet was washed with water and baked at 160° C. for 20 minutes and cooled with air. After cooling, the weight of the film was measured. In addition, the predetermined voltage was assumed to be voltage by which a film thickness of 15 μm was attained in 3 minutes.
Film resistance value per unit mass=(V×S)/(I×W)
V: Voltage of coating
S: Area of article to be coated (cm²)
I: Residual current (A)

W: Weight of film (mg)

TABLE 1

| | | | | | | | Comparative | |
|---|---|---|---|---|---|---|---|---|
| | | Example | | | | | Example | |
| | | 1 | 2 | 3 | 4 | 5 | 1 | 2 |
| Throwing power | Ratio (G/A) between | 62.5 | 66.7 | 64.5 | 66.2 | 62.9 | 71.4 | 40.0 |
| | film thickness of G | | | | | | | |
| | surface and A surface | | | | | | | |
| | (%) when G = 10 mm | | | | | | | |
| Ability of preventing a | 240 V | ⊚ | ⊚ | ⊚ | ⊚ | ◯ | X | ⊚ |
| pinhole due to gas | 220 V | ⊚ | ⊚ | ⊚ | ⊚ | ◯ | X | ⊚ |
| | 200 V | ⊚ | ⊚ | ⊚ | ⊚ | ◯ | ⊚ | ⊚ |
| Film resistance value | 4 seconds | 0.60 | 0.91 | 0.72 | 0.65 | 0.80 | 1.20 | 0.64 |
| per unit weight | 10 seconds | 2.22 | 2.44 | 2.37 | 2.20 | 2.08 | 1.30 | 1.72 |
| (kΩ · cm²/mg) | | | | | | | | |

In Table 1 the ability of preventing a pinhole due to gas was improved without loss of throwing power in Examples. On the other hand, in Comparative Example 1, the ability of preventing a pinhole due togas was poor and in Comparative Example 2, the throwing power was low.

From these results, it is understood that in Examples, the ability of preventing a pinhole due to gas was improved without loss of throwing power. And, in Examples, the film resistance value per unit weight was suppressed at 4 seconds and increased at 10 seconds.

### INDUSTRIAL APPLICABILITY

The method of forming a cationic electrodeposition film and the cationic electrocoating composition of the present invention can be suitably applied to the formation of under films of large articles to be coated such as an automobile body.

1. A method of forming a cationic electrodeposition film, comprising immersing an article to be coated, composed of a galvanized steel sheet, into a bath tank filled with a cationic electrocoating liquid containing a base resin and forming an electrodeposition film on the surface of said galvanized steel sheet by current-carrying,
wherein an electric through hole is formed within said film to secure the conductivity of said film in order to wipe out a spark discharge phenomenon arising due to the presence of a hydrogen bubble produced through cohesion of hydrogen gas, with the passage of time, generated by said current-carrying at a gap of the film, which develops in depositing/forming the film by said current-carrying and increasing its thickness with the passage of time, on the surface of said galvanized steel sheet, and
thereby an increase in an electric resistance value (kΩ·cm²) per unit weight (mg) of said film is inhibited.

2. The method of forming a cationic electrodeposition film according to claim 1,
wherein a component composing said film comprises said base resin, said base resin is an amine-modified epoxy resin and said electric through hole is formed by locating an acid group (—COO—) in the vicinity of an end amino group of said amine-modified epoxy resin.

3. The method of forming a cationic electrodeposition film according to claim 2,
wherein the acid group (—COO—) is a product of a reaction of an acid anhydride and an amino group.

4. The method of forming a cationic electrodeposition film according to claim 1,
wherein said electric through hole is one formed by locating an acid group derived from a resin containing an acid group, which is poorly soluble in water.

5. The method of forming a cationic electrodeposition film according to claim 1,
wherein said electric through hole is one formed by locating an acid group derived from an amphoteric ion group-containing resin.

6. A method of forming a cationic electrodeposition film, comprising immersing an article to be coated, composed of a galvanized steel sheet, into a bath tank filled with a cationic electrocoating liquid containing a base resin and forming an electrodeposition film on the surface of said galvanized steel sheet by current-carrying,
wherein a spark discharge phenomenon in a hydrogen bubble on the surface of said galvanized steel sheet is inhibited by controlling an increase in an electric resistance value (kΩ·cm²) per unit weight (mg) of the film deposited/formed by said current-carrying.

7. A method of forming a cationic electrodeposition film, comprising immersing an article to be coated, composed of a galvanized steel sheet, into a bath tank filled with a cationic electrocoating liquid containing a base resin and forming an electrodeposition film on the surface of said galvanized steel sheet by current-carrying,
wherein an electric resistance value (kΩ·cm²) per unit weight (mg) of the film deposited/formed by said current-carrying is 1.0 or less within 4 seconds after said current-carrying is initiated and 2.0 or more after a lapse of 10 seconds after said current-carrying is initiated.

8. A method of forming a cationic electrodeposition film, comprising immersing an article to be coated, composed of a galvanized steel sheet, into a bath tank filled with a cationic electrocoating liquid containing a base resin and forming an electrodeposition film on the surface of said galvanized steel sheet by current-carrying,
wherein an increase in an electric resistance value (kΩ·cm²) per unit weight (mg) of said film is suppressed for 4 seconds from the initiation of current-carrying in order to wipe out a spark discharge phenomenon arising due to the presence of a hydrogen bubble produced through cohesion of hydrogen gas, with the passage of time, generated by said current-carrying at a gap of the film, which develops in depositing/forming the film by said current-carrying and increasing its thickness with the passage of time, on the surface of said galvanized steel sheet.

9. The method of forming a cationic electrodeposition film according to claim 7,
wherein said current-carrying condition is a manner in which voltage is elevated at a constant rate in a condition of selecting 5 seconds as a duration until reaching a predetermined applied voltage and
in this condition a temperature of a bath liquid is 20 to 40° C. during coating,
a concentration of non-volatile matter of a bath liquid is 15 to 25% by weight during coating,
an area ratio between an article to be coated and an electrode is 1:1 to 2:1 and a distance between electrodes is 15 cm.

10. A cationic electrocoating composition containing a base resin
which can secure the conductivity of a film by forming an electric through hole within a film deposited/formed by current-carrying during cationic electrodeposition process, and inhibit an increase in an electric resistance value (kΩ·cm²) per unit weight (mg) of said film.

11. The cationic electrocoating composition according to claim 10,
wherein a component composing said film comprises said base resin, said base resin is an amine-modified epoxy resin and said electric through hole is formed by locating an acid group (—COO—) in the vicinity of an end amino group of said amine-modified epoxy resin.

12. The cationic electrocoating composition according to claim 11,
wherein the acid group (—COO—) is a product of a reaction of an acid anhydride and an amino group.

13. The cationic electrocoating composition according to claim 10,
wherein said electric through hole is one formed by locating an acid group derived from a resin containing an acid group, which is poorly soluble in water.

14. The cationic electrocoating composition according to claim 10,
wherein said electric through hole is one formed by locating an acid group derived from an amphoteric ion group-containing resin.

15. A cationic electrocoating composition
which can control an increase in an electric resistance value (kΩ·cm²) per unit weight (mg) of a film deposited/formed by current-carrying during cationic electrodeposition process.

16. A cationic electrocoating composition
which can render an electric resistance value (kΩ·cm²) per unit weight (mg) of a film deposited/formed by current-carrying during cationic electrodeposition process 1.0 or less within 4 seconds after the current-carrying is initiated and 2.0 or more after a lapse of 10 seconds after the current-carrying is initiated.

17. A cationic electrocoating composition
which can suppress an increase in an electric resistance value (kΩ·cm²) per unit weight (mg) of a film for 4 seconds from the initiation of current-carrying in order to wipe out a spark discharge phenomenon arising due to the presence of a hydrogen bubble produced through cohesion of hydrogen gas, with the passage of time, generated by said current-carrying at a gap of the film, which develops in depositing/forming the film by current-carrying during cationic electrodeposition process and increasing its thickness with the passage of time.

18. The cationic electrocoating composition according to claim 16,
wherein said current-carrying condition is a manner in which voltage is elevated at a constant rate in a condition of selecting 5 seconds as a duration until reaching a predetermined applied voltage and
in this condition a temperature of a bath liquid is 20 to 40° C. during coating,
a concentration of non-volatile matter of a bath liquid is 15 to 25% by weight during coating,
an area ratio between an article to be coated and an electrode is 1:1 to 2:1 and a distance between electrodes is 15 cm.

19. The method of forming a cationic electrodeposition film according to claim 8,
wherein said current-carrying condition is a manner in which voltage is elevated at a constant rate in a condition of selecting 5 seconds as a duration until reaching a predetermined applied voltage and
in this condition a temperature of a bath liquid is 20 to 40° C. during coating,
a concentration of non-volatile matter of a bath liquid is 15 to 25% by weight during coating,
an area ratio between an article to be coated and an electrode is 1:1 to 2:1 and a distance between electrodes is 15 cm.

20. The cationic electrocoating composition according to claim 17,
wherein said current-carrying condition is a manner in which voltage is elevated at a constant rate in a condition of selecting 5 seconds as a duration until reaching a predetermined applied voltage and
in this condition a temperature of a bath liquid is 20 to 40° C. during coating,
a concentration of non-volatile matter of a bath liquid is 15 to 25% by weight during coating,
an area ratio between an article to be coated and an electrode is 1:1 to 2:1 and a distance between electrodes is 15 cm.
